(19) United States
(12) Patent Application Publication
(10) Pub. No.: US 2004/0218587 A1
(43) Pub. Date: Nov. 4, 2004

(54) Private EV-DO system sharing public network data location register and data service method

(76) Inventors: Sung-Hoon Kim, Suwon-si (KR); Tai-Yoon Lee, Suwon-si (KR); Doo-Yong Yang, Seoul (KR)

Correspondence Address: Robert E. Bushnell, Suite 300, 1522 K Street, N.W., Washington, DC, 20005-1202, US

(21) Appl. No.: 10/826,370

(22) Filed: Apr. 19, 2004

(30) Foreign Application Priority Data
Apr. 29, 2003 (KR) 2003-27342

(51) Int. Cl. H04L 12/56

(52) U.S. Cl. 370/352; 370/400; 370/338

(57) ABSTRACT

Disclosed is a data service method in a private EV-DO wireless network system sharing a public network data location register (DLR). The method, in the private EV-DO wireless network system being interworked with a public EV-DO wireless network system, comprises the steps of: analyzing a message received from a private EV-DO network terminal to request the public network access network control (ANC) to perform a public network connection or request the private access network control (pANC) to perform a private network connection when an access network transceiver system (ANTS) receives a public network or private network call request from the private EV-DO network terminal; requesting and receiving, by the public network access network control (ANC) receiving the public network connection request, the public network data location register (DLR) to provide terminal session information for terminal authentication performance, or of requesting and receiving, by the private access network control (pANC) receiving the private network connection request, the terminal session information for the terminal authentication performance by communication through the public network data location register (DLR) and the dedicated line; and performing the authentication according the received session information and then performing the private network connection by the private access network control (pANC) or the public network connection by the public network access network control (ANC).

### CLAIM OF PRIORITY AND CROSS-REFERENCE TO RELATED APPLICATIONS

This application makes reference to, incorporates the same herein, and claims all benefits accruing under 35 U.S.C. §119 from an application for PRIVATE EV-DO SYSTEM SHARING PUBLIC NETWORK DATA LOCATION REGISTER AND DATA SERVICE METHOD USING THE SAME earlier filed in the Korean Intellectual Property Office on 29 Apr. 2003 and there duly assigned Serial No. 2003-27342.

Furthermore, the present application is related to two co-pending U.S. applications, Serial No. (to be determined), entitled PERFORMING TERMINAL AUTHENTICATION AND CALL PROCESSING IN PRIVATE WIRELESS HIGH-SPEED DATA SYSTEM, based upon Korean Patent Application Serial No. 2003-27343 filed in the Korean Intellectual Property Office on 29 Apr. 2003, and filed in the U.S. Patent & Trademark Office concurrently with the present application, and Serial No. (To be determined), entitled PRIVATE WIRELESS HIGH-SPEED DATA SYSTEM AND DATA SER VICE METHOD, based upon Korean Patent Application Serial No. 2003-27335 filed in the Korean Intellectual Property Office on 29 Apr. 2003, and filed in the U.S. Patent & Trademark Office concurrently with the present application.

### BACKGROUND OF THE INVENTION

1. Field of the Invention

The present invention relates to a private evolution data only (EV-DO) system sharing a public network data location register (DLR) and a data service method and, more particularly, to a private EV-DO system sharing a public network DLR and a data service method capable of simultaneously providing public EV-DO wireless network service and private EV-DO wireless network service using a wireless terminal of one wireless high-speed data system CDMA 1×EV-DO (hereinafter, referred to as an EV-DO) scheme.

2. Description of the Related Art

A synchronous code division multiple access (CDMA) mobile communication system is classified into CDMA One of an existing IS-95 series and CDMA 2000 which is an IS-2000 series for IMT-2000 according to a wireless section protocol.

In the mobile communication industry, substantial data service as well as voice service using a CDMA channel was expected when the CDMA 2000 system was announced. However, the data service has many factors, unlike the voice service. For example, a distance from a base station to a terminal, the load of a voice channel in the base station, or the like acts as a factor in determining a substantial transmission rate for users.

Qualcomm has suggested a variant system called HDR (High Data Rate) in the course of the CDMA 2000 system. The name HDR was then changed to the name 1×EV-DO (Evolution Data Only), which has been introduced for adoption as a standard in the 3GPP2 committee.

A draft standard of the EV-DO system was agreed upon on December 2000, and a formal name of the system is a high rate packet data system. It was adopted as a formal technology standard in the name of ‘CDMA2000 1×EV-DO (Evolution Data Only)’ by the 3GPP2 committee, which is the synchronous International Standard Organization, on October 2001 and is commonly called ‘synchronous 3rd generation (IMT-2000) service’.

The EV-DO system is a scheme evolved from the CDMA 2000 1× in order to send packet data only, and has a much improved transmission speed as compared to the CDMA2000 1×.

The most significant difference between the EV-DO system and the CDMA 2000 system is that the former serves only data. In other words, the EV-DO system allows a traffic channel, outputted from a base station, to be sent to only one subscriber at one instant.

EV-DO has evolved because the 1×RTT system of an IMT-2000 MC (Multi-Carrier; synchronous) system, which has been developed to support both voice and data and has been tested for commercial use, has a high-speed data transmission bandwidth limit of 1.25 MHz and does not support a data transmission of 144 Kbps or more in an IS-95 scheme. EV-DO is therefore a supplementary solution for high-speed data transmission.

CDMA 2000 1×EV (Evolution)-DO (Data Only) is a high-speed data-only communication network. There is a significant difference between a conventional IS-95 or 1×RRT network and the 1×EV-DO network in that the former intensively serves voice and provides low-speed data transmission while the latter serves only high-speed data. This 1×EV-DO network uses a dedicated protocol for packet data transmission, which is completely different from a conventional IS-2000 wireless protocol.

Considering the characteristics of packet data, since service in which an access terminal downloads from a system (e.g., Internet) is superior, 1×EV-DO has a structure in which forward and backward channel speeds are different.

For instance, it has an asymmetric data rate structure providing forward (base station→terminal) maximum data rate of 2.4 Mbps and backward (terminal→base station) maximum data rate of 307.2 Kbps.

That is, EV-DO can support a data rate which is exactly the same as the existing data rate even in a third generation (3G) network by making a data dedicated Internet connection over a data core network (DCN) in the IS-95 network.

EV-DO is a concept of allocation and extension of spare RF frequencies in the IS-95A, B system, which are conventionally used, wherein an antenna for the conventional system is available. It can advantageously provide highly efficient data service with a reduced investment cost while not providing a handoff between a base station and another base station.

That is, EV-DO, which is a data dedicated network, has been developed for the purpose of enhancing the quality of data. Simultaneous service of EV-DO and IS-95 can be provided by disposing EV-DO in a region where the most data is being used in a conventionally served network.

In an aspect of transmission speed according to the quality, EV-DO has an average forward transmission speed making high-speed data communication of several hundred kbps possible. It has a wireless frequency bandwidth of 1.25 MHz, which is the same as a mobile phone used in a current CDMA One.

Considering that a bandwidth of 5 MHz is required to provide 384 bps service in the IMT-2000, EV-DO has a much higher frequency usage efficiency.

That is, EV-DO has been designed in a manner suitable for data communication that is not affected by delay or when transfer data is burst data as in the Internet, realizing a high-speed transmission with a frequency bandwidth narrower than that of IMT-2000.

Further, EV-DO performs a function of automatically adjusting the backward transmission speed at a base station side according to the communication quality between a terminal and a base station. This function is realized by monitoring a signal from the terminal received at the base station every 1.67 milliseconds to determine the communication quality and by adjusting the data transmission priority and speed with the terminal.

EV-DO improves data communication quality by preferentially increasing transmission speed for a terminal in the vicinity of the base station where electrical interference is less while reducing communication speed for a terminal located far from the base station.

Thus, by optimizing a system to be suitable for high-speed packet transmission, it is possible to transmit data such as text, video, music or the like at a maximum speed of 2.45 Mbps at a narrower bandwidth of 1.25 Mhz, which is 20 times higher than the about 144 Kbps speed of the conventional CDMA2000-1×.

Accordingly, using EV-DO technology realizes mega class data transmission specific to the third generation communication, which allows very high-speed wireless multimedia service such as real time moving picture implementation through a videophone or terminal. For example, the conventional CDMA2000 1× consumes four to five minutes when downloading an MP3 moving picture file while the downloading speed can be shortened to about 10 seconds in the EV-DO environment, which allows a natural moving picture service of 10 or more frames per second to be implemented.

EV-DO is advantageous in network compatibility because the CDMA mobile communication network can send data to the Internet network, not through a voice core network.

Further, an attractive feature of EV-DO is that it uses synchronous technology, it can be compatible to IS-95A/B and CDMA2000 1× in a data field and accordingly is suitable for the upgrade of conventional systems, and it is possible to minimize initial facility investment because the CDMA2000 1× system network can be used without any modifications.

A typical wireless network is classified into a wireless public network and a wireless private network, which is used at groups, companies, or the like having a particular purpose. The wireless private network is configured to interwork with a specific wireless public network. On the other hand, in a EV-DO wireless network, only public EV-DO wireless network service provided by a mobile communication service provider exists while there is no private EV-DO wireless network service, unlike the typical wireless network.

Thus, methods are being developed which use a part of a public EV-DO wireless network as a private EV-DO wireless network. These methods allow one mobile terminal to be served by the private EV-DO wireless network in a particular region (private region) while being served by the public EV-DO wireless network in other regions.

The following patents each discloses features in common with the present invention but do not teach or suggest the inventive features specifically recited in the present application: U.S. patent application Ser. No. 2004/0048601 to Lee, entitled METHOD AND SYSTEM FOR USING EITHER PUBLIC OR PRIVATE NETWORKS IN 1×ev-DO SYSTEM, published on Mar. 11, 2004; U.S. patent application Ser. No. 2003/0078047 to Lee et al., entitled APPARATUS, METHOD AND SYSTEM FOR MATCHING SUBSCRIBER STATES IN NETWORK IN WHICH PUBLIC LAND MOBILE NETWORK AND WIRED/WIRELESS PRIVATE NETWORK ARE INTER WORKED, published on Apr. 24, 2003; U.S. patent application Ser. No. 2003/0069013 to Lee et al., entitled APPARATUS, METHOD AND SYSTEM FOR MATCHING SUBSCRIBER STATES IN NETWORK IN WHICH PUBLIC LAND MOBILE NETWORK AND WIRED/WIRELESS PRIVATE NETWORK ARE INTERWORKED, published on Apr. 10, 2003; U.S. Pat. No. 6,704,569 to Larson, entitled CENTRALIZED USER DATABASE AND ADMINISTRATIVE NODE CONNECTING PRIVATE AND PUBLIC WIRELESS COMMUNICATIONS SYSTEMS, issued on Mar. 9, 2004; U.S. Pat. No. 6,697,621 to Taha et al., entitled METHOD AND APPARATUS FOR PROVIDING SERVICES IN A PRIVATE WIRELESS NETWORK, issued on Feb. 24, 2004; and U.S. Pat. No. 6,687,213 to Sayers et al., entitled METHOD AND APPARATUS FOR INTEGRATED WIRELESS COMMUNICATIONS IN PRIVATE AND PUBLIC NETWORK ENVIRONMENTS, issued on Feb. 3, 2004.

### SUMMARY OF THE INVENTION

It is an object of the present invention to provide a private EVDO system sharing a public network DLR, which shares the DLR when providing private EV-DO wireless network service in one region and also when providing public EV-DO wireless network service in other regions.

According to an aspect of the present invention for achieving this object, there is provided a public EV-DO wireless network having a public network data location register (DLR) and a public network access network control (ANC); a private EV-DO wireless network interfacing with the public EV-DO wireless network and providing private EV-DO wireless data service, the private EV-DO wireless network comprising: a private access network control (pANC) coupled to the public network access network control (ANC) and adapted to provide a link between the private EV-DO network and the public EV-DO network, wherein the private access network control (pANC) is adapted to request session information of a private network EV-DO terminal to perform terminal authentication through the public network data location register (DLR) and to allocate a traffic channel and establish a Switched Virtual Circuit (SVC) to provide a private network connection or an Internet connection according to the received session information; and an access network transceiver system (ANTS) having a defined wireless area, wherein, when one of a public network and a private network is called from a private network EV-DO terminal entering the defined wireless area, the access network transceiver system (ANTS) is adapted to analyze a message sent from the terminal, and to request one of the public network access network control (ANC) or private access network control (pANC) to perform the corresponding public network or private network connection.

Here, the link between the private EV-DO network and the public EV-DO network comprises an A14 interface.

In addition, the public network data location register (DLR) is adapted to store location information and authentication information of either private or public network EV-DO terminals and to provide information needed for call processing upon a call connection from an arbitrary EV-DO terminal being established. Furthermore, the public network data location register (DLR) is adapted to perform at least one of a session creation and release function, a unicast access terminal identifier (UATI) allocation and deletion function, a self database holding function, a session maintenance confirming function, a paging command transmission function, and an interfacing function with a neighboring data location register (DLR).

The access network transceiver system (ANTS) comprises a router module adapted to determine whether the originated data call is an originating call for connection to the public network or an originating call for connection to the private network based on an identifier contained in a data call originated from the private network EV-DO terminal, to rout the call to an access network control (ANC) in the public EV-DO network upon the originating call being a public network connection originating call, and to rout the originating call to the private access network control (pANC) to be processed in the private network EV-DO network upon the originating call being a private network connection originating call.

The system can further comprise a pAN_AAA adapted to receive session information on an arbitrary private network EV-DO terminal from the public network data location register (DLR) through the private access network control (pANC) to perform authentication for the corresponding terminal; a private packet data service node (pPDSN) coupled to the private access network control (pANC) and adapted to provide Internet service to the private network EV-DO terminal through an Intranet; and a wireless base system manager (WSM) adapted to perform loading, failure, diagnosis, and statistics in the private EV-DO wireless network according to the traffic channel allocation and the SVC establishment by the private access network control (pANC).

According to another aspect of the present invention, there is provided providing a public EV-DO wireless network including a public network data location register (DLR) and a public network access network control (ANC); interfacing a private EV-DO wireless network with the public EV-DO wireless network; the private EV-DO wireless network adapted to perform a network connection request including analyzing a message received from a private EV-DO network terminal to request the public network access network control (ANC) to perform a public network connection or to request the private access network control (pANC) to perform a private network connection upon an access network transceiver system (ANTS) receiving one of a public network call request and a private network call request from the private EV-DO network terminal; the private EV-DO wireless network adapted to perform a session information allocation including requesting and receiving the public network data location register (DLR) to provide terminal session information for terminal authentication performance from the public network access network control (ANC) receiving the public network connection request, or of requesting and receiving the terminal session information for the terminal authentication performance from the private access network control (pANC) receiving the private network connection request by communication through the public network data location register (DLR); and the private EV-DO wireless network adapted to perform a network connection including performing the authentication according the received session information and performing the private network connection with the private access network control (pANC) or performing the public network connection with the public network access network control (ANC).

The public network data location register (DLR) is adapted to store location information and authentication information of either private or public network EV-DO terminals and to provide information needed for call processing upon a call connection from an arbitrary EV-DO terminal being established.

The public network data location register (DLR) is adapted to perform at least one of a session creation and release function, a UATI allocation and deletion function, a self database holding function, a session maintenance confirming function, a paging command transmission function, and an interfacing function with a neighboring data location register (DLR).

The access network transceiver system (ANTS) includes a router module adapted to determine whether the originated data call is an originating call for connection to the public network or an originating call for connection to the private network based on an identifier included in a data call originated from the private network EV-DO terminal, to rout the call to an access network control (ANC) in the public EV-DO network upon the originating call being a public network connection originating call, and to rout the originating call to the private access network control (pANC) to be processed in the private network EV-DO network upon the originating call being a private network connection originating call.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings in which like reference symbols indicate the same or similar components, wherein:

FIG. 1 is a schematic configuration diagram of a mobile communication system for 1×EV-DO service;

FIG. 2 is a diagram of a network connection configuration of a private EV-DO system sharing a public network DLR according to an embodiment of the present invention;

FIG. 3 is a flowchart of a call processing procedure when a private call is called in a private EV-DO system sharing a public network DLR according to an embodiment of the present invention;

FIG. 4 is a flowchart of a call processing procedure when a public network call is called in a private EV-DO system sharing a public network DLR according to an embodiment of the present invention;

FIG. 5 is a message flowchart for a message routed to a public network ANC;

FIG. 6 is a message flowchart for a message routed to a private network pANC; and

FIG. 7 is a flowchart for a security process performed by an ANMR.

### DETAILED DESCRIPTION OF THE INVENTION

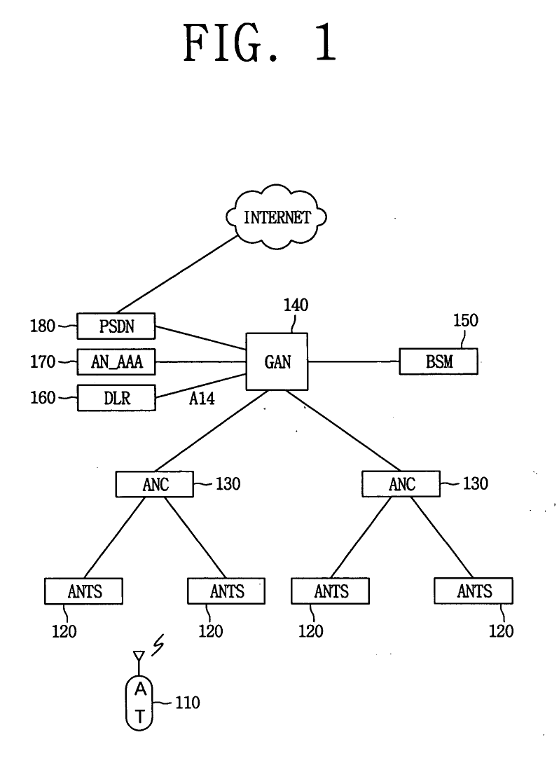

FIG. 1 is a schematic configuration diagram of a mobile communication system for 1×EV-DO service. As shown, considering the 1×EV-DO in an aspect of a network structure, a wireless IP network structure defined in the IS-835 can be also applied to the packet data system without any modifications.

FIG. 1 is a connection configuration diagram of a network performing public EV-DO service.

Referring to FIG. 1, a mobile communication system for 1×EV-DO service includes a plurality of access terminals (ATs) 110, an access network transceiver system (ANTS) 120 serving as a public network base station, an access network control (ANC; public control station) 130, a global area network (GAN) 140 serving as a hub, a base system manager (BSM) 150, a data location register (DLR) 160, authentication authorization accounting (AAA) server 170, and a packet data service node (PDSN) 180.

The wireless terminal 110 is a device providing data connectivity to a user. The terminal can be a mobile communication terminal enabling a user to communicate while holding it and moving or can be a device connected to an information processing device such as a laptop computer or the like, or embedded with a data processing function such as a personal digital assistant (PDA).

The access network transceiver system (ANTS; public network base station) 120 has a given public wireless area. If the terminal enters the area of ANTS, the corresponding ANTS establishes a session and performs an operation needed while allocating a unicast access terminal identifier (UATI) which is necessary for the corresponding AT 110.

Further, the ANTS 120 allows the terminal 110 to receive a call or relays a call connection request signal to the access network control (ANC) 130 connected to the global area network (GAN) 140 when there is a call connection request from the AT 110.

The GAN 140 is connected to a base system manager (BSM) 150 responsible for loading, failure, diagnosis, statistics, or the like of the system, the DLR 160 responsible for storing information on the terminals, location information of the terminals, or the like, the access network authentication authorization accounting (AN_AAA; private authentication system) server 170 responsible for public network authentication, public network terminal authentication, or the like, and the packet data serving node (PDSN) 180 performing Internet service on the terminals.

The DLR 160 stores the information and location information of the terminals 110 registered in the public EV-DO wireless network, and provides the information of the terminal 110 while updating the session of the corresponding terminal.

The authentication authorization accounting (AAA) server 170 performs authentication, right authorization, and accounting functions for users. To perform such functions, the server uses a RADIUS protocol and performs a service accounting information collecting function, a mobile IP registration authenticating function, a dial-in service user authenticating/right verifying function, or the like.

Hereinafter, exemplary embodiments of a private EV-DO system sharing a public network DLR and a data service method will be described in detail with reference to the accompanying drawings.

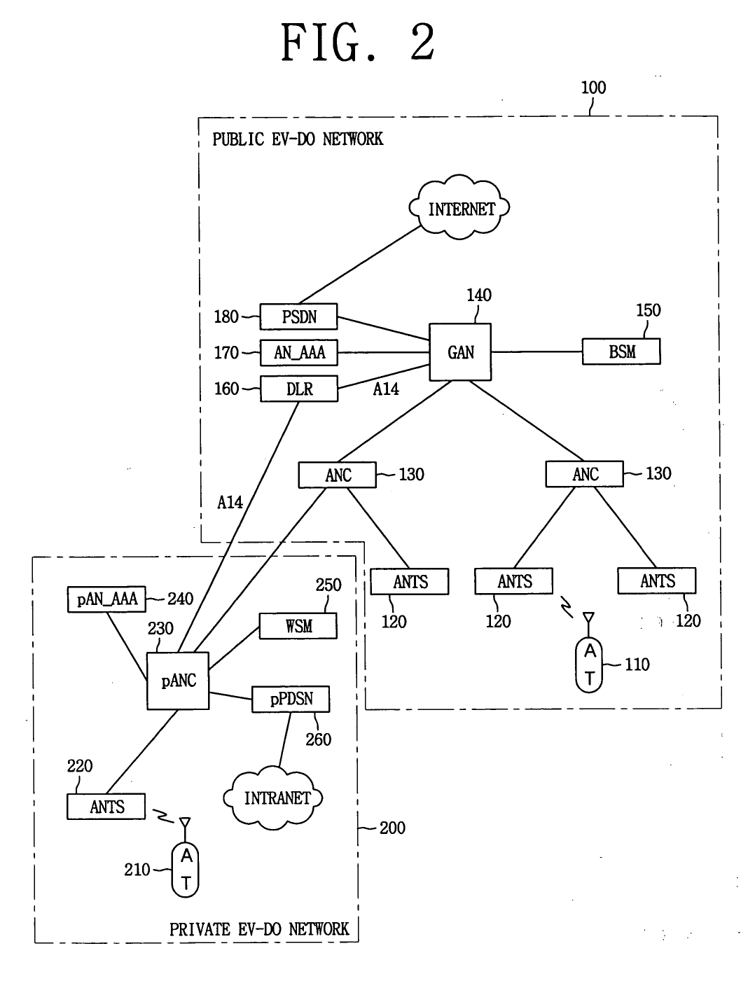

FIG. 2 is a diagram of a network connection configuration of a private EV-DO system sharing a public network DLR according to an embodiment of the present invention. Referring to FIG. 2, the private EV-DO system sharing a public network DLR is composed of a public EV-DO wireless network 100 for providing EV-DO service in a public network, and a private EV-DO wireless network 200 for providing EV-DO service in a private network.

A wireless terminal (AT) 110 is a terminal that can be used in common in the public EV-DO wireless network 100 and the private EV-DO wireless network 200, and a terminal 210 in the private EV-DO wireless network 200 is a terminal registered in the public EV-DO wireless network 100 and can be also used in common in the private EV-DO wireless network 200.

Further, access network transceiver systems (ANTSs; public network base stations) 120 in the public EV-DO wireless network 100 have given public wireless areas, respectively. If the terminal enters the area of the ANTS, the corresponding ANTS establishes a session and performs an operation needed while allocating a unicast access terminal identifier (UATI) which is necessary for the corresponding terminal 110.

Further, the ANTS 120 allows the AT 110 to receive a call, or relays a call connection request signal to the access network control (ANC; public control station) 130 when there is a call connection request from the AT 110.

The ANC 130 is connected to a global area network (GAN) 140 serving as a hub, and the GAN 140 in turn is connected to an access network authentication authorization accounting (AN_AAA) server 170, serving as a private authentication system, which is responsible for public network authentication, public network terminal authentication or the like, a packet data serving node (PDSN) 180 for performing Internet service for the terminals, a data location register (DLR) 160 for storing information on terminals, location information of the terminals or the like, and a base system manager (BSM) 150 which is responsible for loading, failure, diagnosis, statistics or the like of a system. The GAN performs a data relay between the respective nodes.

The DLR 160 stores information and location information of the terminals 110 and 210 registered in the public EV-DO wireless network 100, and provides the information of the terminals 110 and 210 while updating the session of the corresponding terminal. The DLR 160 also stores information on terminals included in a typical wireless public network. The terminal information of the typical wireless public network can include at least one of terminal information, user information, and service class information.

In addition, the DLR 160 stores location information and other authentication information of the private EV-DO terminal AT 210. Then, when a call connection from the private EV-DO terminal AT 210 is established, the DLR 160 provides information needed for call processing, and performs the authentication of the private EV-DO terminal AT 210 using the stored terminal authentication information.

Further, the public DLR 160 can perform a session creation and release function, a UATI allocation and deletion function, a self database holding function, a session maintenance confirmation function, a paging command transmission function and an interfacing function with a neighboring DLR.

Meanwhile, ANTS 220 in the private EV-DO wireless network 200 provides an incoming call to the AT 210 entering the private area, or relays a call connection signal to a private access network control (pANC) 230 serving as a private control station when a call connection from the AT 210 is established.

The pANC 230 can comprise a router module (ANMR; not shown) that determines, based on an identifier included in a data call originated by the AT 210, whether the originated data call is an originated call for connecting to the public network or an originated call for connecting to the private network, and routes the originated call to the ANC 130 in the public EV-DO wireless network 100 when it is an originated call for the public network connection and routes the originated call to be handled in the private network EV-DO wireless network 200 when it is an originated call for the private network connection.

ANMR has a predetermined specific server address. It compares this server address to temporary identifier information, and, when there is a call request to a temporary identifier terminal, having a specific server, of which the temporary identifier address is predefined, detects the call as a call in the private EV-DO wireless network 200 to route the corresponding call to the pANC 230.

For example, a temporary identifier of a private EV-DO wireless network 200 subscriber is allocated to have a predetermined server address. If the predetermined server address is, for example, a server for “samsung.co.kr”, the terminal AT 210 in the private EV-DO wireless network 200 can have an address of “111@samsung.co.kr”.

Thus, when a call connection of the AT 210 in the private EV-DO wireless network 200 to one of predetermined server addresses is requested or a call connection is requested with a terminal having the above server, for example, a terminal for “aaa@samsung.co.kr”, it is determined to be a call in the private EV-DO wireless network 200.

If any one of a server included in the temporary identifier of the AT 210 requesting a call, a server which is required to receive a call, and a temporary identifier server of a terminal which is required to receive a call does not have a predetermined address, the corresponding call is determined to be the public EV-DO wireless network 100 connection call and is routed to the ANCs 130a and 130b in the public EV-DO wireless network 100.

Further, a pPDSN 260 is connected to the pANC 230 for providing Internet service to the private EV-DO terminal AT 210 through an Intranet and a wireless base system manager(WSM) 250 is also connected which is responsible for loading, failure, diagnosis, statistics or the like of the private EV-DO wireless network 200 system. The above-described network components in the private EV-DO wireless network 200 are similar to the components used in the public EV-DO wireless network 100 in their nature and function.

In addition, the pANC 230 is located at an intermediate point of a link between the ANC 130 and the ANTS 220, and the ANC 130 does not recognize the existence of the pANC 230 but recognizes as directly interfacing with the ANTS 220. The pANC 230 uses the same ID as the ANC 130 to handle messages to and from ANTS 220. The ANMR 221 analyzes and determines whether the message sent to the ANTS 220 is a message to be sent to the ANC 130 or a message to be sent to the pANC 130. The ANMR 221 sends the message to be sent to the ANC 130 to the ANC 130, and sends and processes the message to be processed in the private network to the pANC 230. Accordingly, it is possible to use the same ANTS 220. The pANC 230 handles an A14 message to and from the public network DLR 160 in the same manner as the ANC 130.

The operation of the private EV-DO system sharing a public network DLR according to an embodiment of the present invention configured as above will be discussed in detail below.

The private EV-DO wireless network 200 is configured by adding the pANC 230 between the public network ANTS 120 and the public network ANC 130 and by adding network elements needed for the EV-DO service to the pANC 230.

One important function of the pANC 230 is to discriminate and deliver various messages from the private ANTS 220 to the public EV-DO wireless network 100 and to the private EV-DO wireless network 200. This is served by the router module in the pANC 230, as described above.

For example, when the EV-DO wireless terminal AT 210 located in the private EV-DO wireless network 200 attempts to connect to the public EV-DO wireless network 100, the pANC 230 recognizes an identifier (discriminator) contained in a message which is sent from the private ANTS 220 and delivers the message to the public network ANC 130 so that the terminal AT 210 connects to the public EV-DO wireless network.

Further, when the terminal AT 210 desires to connect to the private EV-DO wireless network 200, the pANC 230, as in the public network, recognizes a discriminator contained in the message which is sent from the private ANTS 220 to enable the pANC 230 to support the private EV-DO wireless network 200 service using network elements disposed in the private area. For reference, the discriminator, which can discriminate the private EV-DO wireless network 200 and the public EV-DO wireless network 100, is provided from the EV-DO wireless terminal AT 210.

The private EV-DO wireless network 200 allows a session established in the public EV-DO wireless network 100 to be maintained in the private EV-DO wireless network 200 as it is, and allows private EV-DO wireless network 200 service to be provided. By doing so, the following advantages can be obtained.

First, the terminal AT 210 present in the private EV-DO wireless network 200 can respond to the public network paging, and prevent the load of the public network DLR from increasing since a process according to a change of the subnet does not occur.

In the end, tasks related to session establishment and deletion generated in the public EV-DO wireless network 100 do not take place in the private EV-DO wireless network 200, and thus, information necessary for carrying out the private EV-DO call processing will be received from the public network DLR 160. The pANC 230 and the public network DLR 160 should be interconnected by a dedicated line in order to request and receive necessary data stored in the public network DLR 160.

There are some problems with private terminal authentication over the private EV-DO wireless network 200 when maintaining the session established in the public EV-DO wireless network 100 and providing the private EV-DO wireless network 200 service. The problem is when the private terminal authentication task is to be carried out.

There is no problem with the AT 210 registered in the public network because, while establishing a terminal session, an authentication task of the corresponding terminal is carried out through the public network AN-AAA 170 following the session establishment process while, because the session establishment and release tasks are not performed in the private EV-DO wireless network 200 as described above, the authentication task itself through the public network AN-AAA 170 is not carried out in the call-processing step when configuring the private EV-DO is wireless network 200. That is, because the authentication through the public network AN-AAA 170 is carried out while establishing a new session following the session initial establishment and the session release, the authentication step cannot be arbitrarily performed in any step where a simple connection only to the network is established.

In the end, the authentication of a corresponding terminal, namely, a task for confirming whether it is an EV-DO terminal authorized by the private EV-DO wireless network 200 is required upon the private EV-DO wireless network 200 connection rather than the session establishment step in the private EV-DO wireless network 200.

Some information is included in the session information delivered by the public network DLR 160. When a terminal, which is not registered in the private network, tries to connect to the private EV-DO wireless network 200 using information necessary for the private authentication of them, the authentication of the private terminal AT 210 is not permitted so that a message of the subsequent step is not sent in the call processing step.

A data service method, corresponding to the above operation, in a private EV-DO wireless network system interfaced with a EV-DO wireless network system according to an embodiment of the present invention, namely, a call processing method in the private EV-DO wireless network 200 will be discussed step by step with reference to the accompanying drawings.

In the present invention, the public network DLR, the subnet of the public network and the subnet of the private network are equal to each other, and accordingly, if the private pANC directly interworks with the public network DLR, a new session is not required upon moving therebetween. Thus, the session allocated in the public network is equally used even in the private network.

There is no problem with public network paging in the private area because the session information held by the DLR 160 is the same as well.

If the AT 210 requests the private network connection, the router module of the ANTS 220 sends a message to the pANC 230, and the pANC 230 requests the public network DLR 160 to provide session information in order to obtain the session information. In response thereto, the public network DLR 160 provides the session information to the pANC 230 and the pANC 230 requests a pAN_AAA 240 to perform the private authentication.

The pAN_AAA 240 is not configured for terminal authentication but rather is configured for private authentication, unlike the public network AN_AAA 170. The pAN_AAA 240 sends a response to the private authentication request to the pANC 230 and the pANC 230 receiving the authentication response then performs SVC establishment and a PPP connection to the pPSDN 260 through the same flow as that of the public network.

If the AT 210 requests a public network connection, the router module of the ANTS 220 sends the message to the ANC 130 and in turn the ANC 130 requests the DLR 160 to provide the session information in order to obtain the session information. Upon receiving a response thereto, the SVC connection is immediately established between the ANC 130 and the ANTS 220 and the PPP connection is established to the public network PSDN.

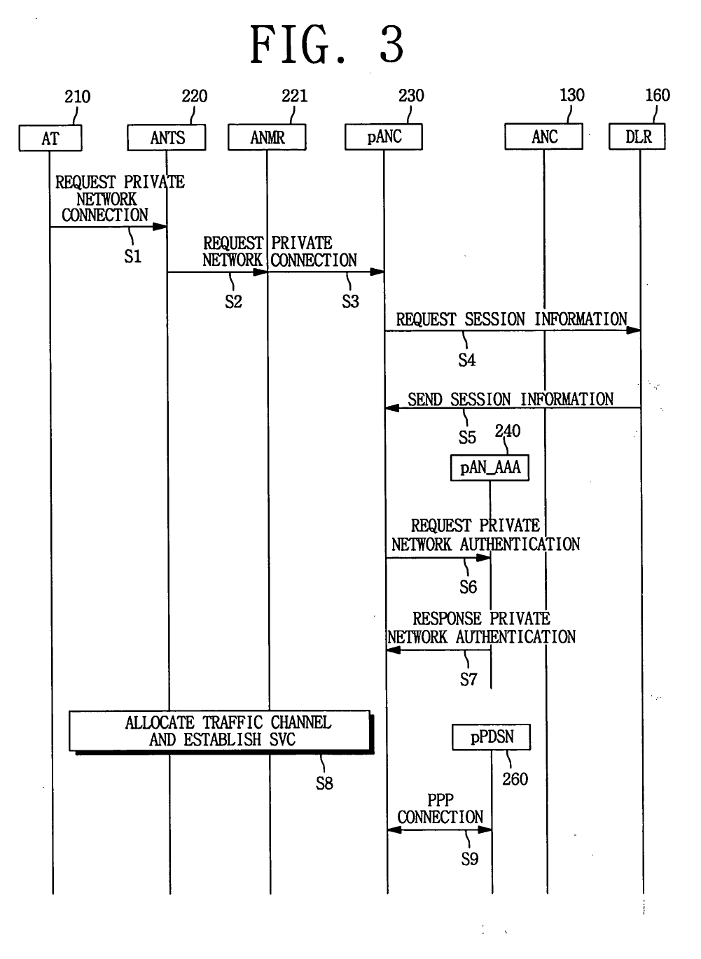

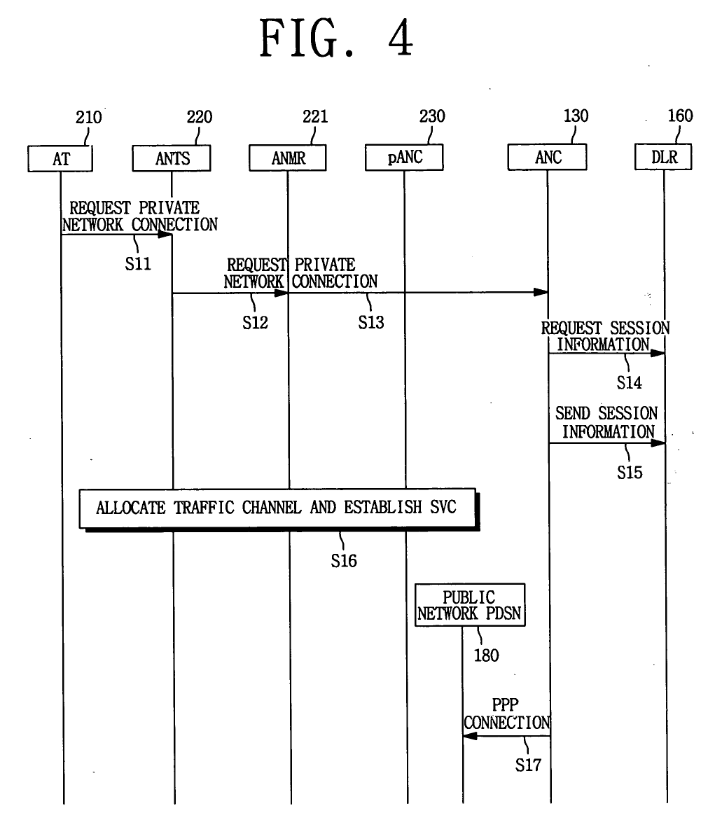

This call processing procedure will be discussed with reference to FIGS. 3 and 4.

FIG. 3 is a diagram of a call processing procedure between a private EV-DO wireless network 200 and a public EV-DO wireless network 100 upon initial call connection when a private call is called in a private EV-DO system sharing a public network DLR according to an embodiment of the present invention, FIG. 4 is a diagram of a call processing procedure between a private EV-DO wireless network 200 and a public EV-DO wireless network 100 upon an initial call connection when a public network call is called.

First, as shown in FIG. 3, if the wireless terminal AT 210 entering the private EV-DO wireless network 200 requests the private EV-DO wireless network 200 to establish a first call connection, the wireless terminal AT 210 sends a request signal for requesting the private EV-DO wireless network 200 connection to the private ANTS 220 (S1).

The private ANTS 220 routes the private network connection request signal sent from the AT 210 to the private pANC 230 through the ANMR 221 being the router module (S2 and S3). The private pANC 230 provides to the DLR 160 a session information request signal for requesting session information needed for the private network connection in response to the private network connection request signal routed through the ANMR 221 from the AT 210 (S4).

The public network DLR 160 retrieves the session information of the corresponding terminal AT 210, requesting the network connection, stored in a database of the public network DLR 160 to send it to the private pANC 230 in response to the session information request message sent from the private pPDLR 240 (S5).

The private pANC 230 sends to the pAN_AAA 240 the session information received from the public network DLR 160 to request private authentication of the corresponding terminal (S6). Accordingly, the pAN_AAA 240 performs the private authentication using the session information of the corresponding terminal AT 210 received from the private pANC 230, and then sends an authentication response signal to the private pANC 230 (S7). That is, some information is contained in the session information of the terminal AT 210 received from the public DLR 160, and authentication information needed for the private authentication of the terminal is contained therein. Thus, the pAN_AAA 240 will determine whether the corresponding terminal is a terminal registered in the private EV-DO wireless network 200 using this authentication information.

When the private authentication is thus completed, the private pANC 230 allocates a traffic channel to the corresponding terminal AT 210 using the session information of the connection request terminal AT 210 sent from the public network DLR 160, and performs a call connection to the terminal AT 210 over the allocated channel (S8).

Thus, when the call connection is established over the allocated channel, the private pANC 230 registers the corresponding terminal AT 210 in the private pPDSN 260 and performs a PPP connection to provide data service over the Intranet (S9).

Meanwhile, referring to FIG. 4, if the wireless terminal AT 210, which has entered the private EV-DO wireless network 200, requests the EV-DO wireless network 100 in the public network to perform a call connection, the wireless terminal AT 210 sends to the private ANTS 220, a request signal for requesting a public network EV-DO wireless network 100 connection (S11).

The private ANTS 220 routes the private network connection request signal sent from the AT 210 through the router 221 to the private public network ANC 130 (S12, S13). The public network ANC 130 provides the DLR 160 with a session information request signal for requesting session information necessary for the private network connection in response to the public network connection request signal from the AT 210 routed through the router 221 (S14).

The public network DLR 160 retrieves the session information on the corresponding terminal AT 210 that has requested a network connection, stored in the database of the public network DLR 160, to send it to the public network ANC 130 in response to the session information request message sent from the public network ANC 130 (S15).

The public network ANC 130 allocates a traffic channel to the corresponding terminal AT 210 using the session information of the connection request terminal (AT) 210 received from the public network DLR 160 and performs a call connection to the terminal AT 210 over the allocated channel (S16).

Thus, when the call connection is established over the allocated channel, the public network ANC 130 registers the corresponding terminal AT 210 in the public network PDSN 180 and performs a PPP connection to provide data service over the Internet (S17).

For such a public network/private call flow, the ANMR is required to sort and send messages to the ANC or to the pANC 230. The ANMR 221 analyzes the message sent to the ANC 130 and the message sent to the pANC 230, and then distributes and sends it to the ANC or to the pANC.

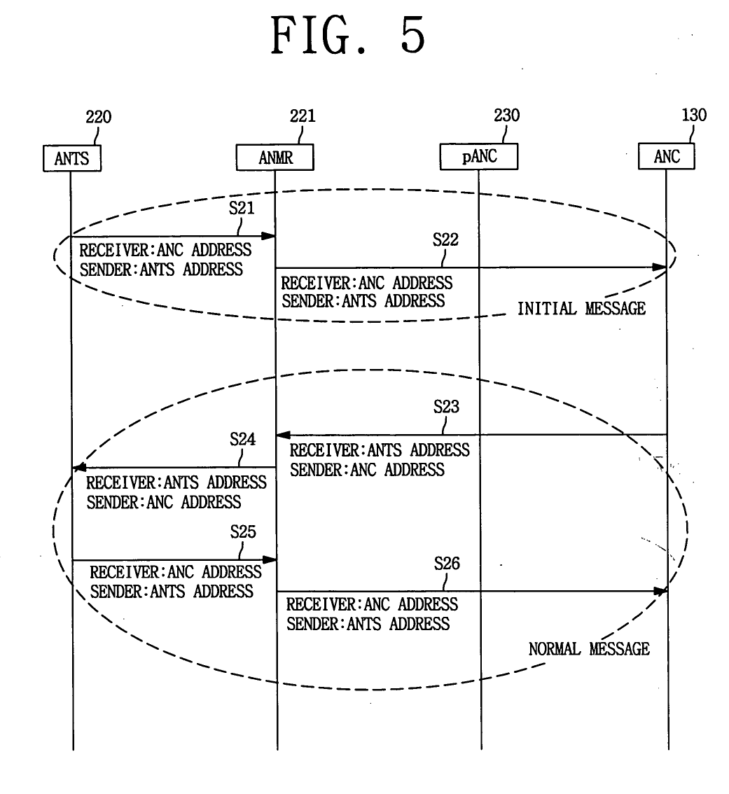

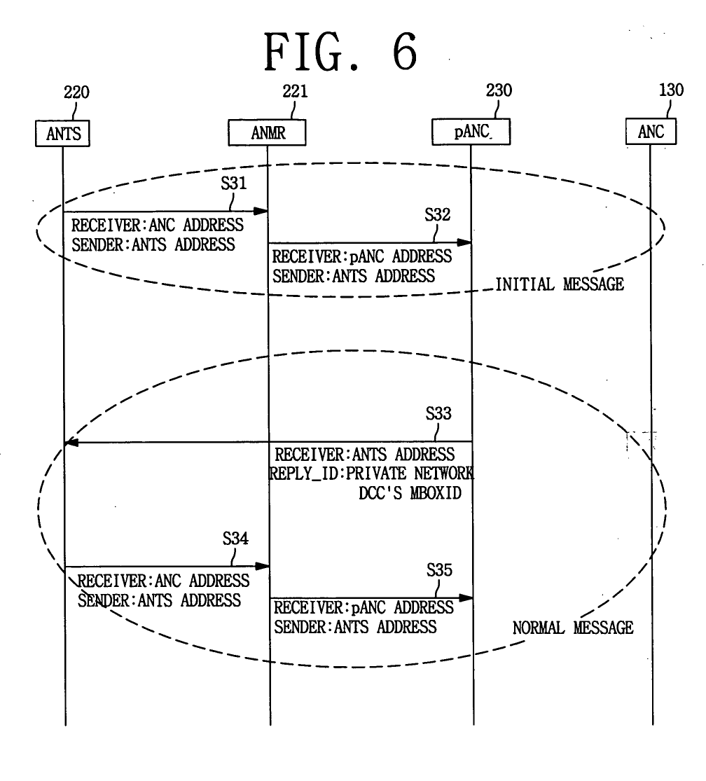

FIG. 5 is a message flowchart during message routing to a public network ANC, and FIG. 6 is a message flowchart during message routing to a private network pANC.

As shown, the ANMR 221 classifies and processes the message into both an initial message and a normal message.

The initial message is defined as the first message among messages communicated between the ANTS 220 and the ANC 130. The ANMR 221 determines whether to send the coming initial message to the ANC 230 or to the pANC 230 using a discriminator.

First, referring to FIG. 5, when a message having the ANTS address as a sender and the ANC address as a receiver is delivered from the ANTS 220 to the ANMR 221 (S21), the ANMR 221 delivers this message to the pANC 230 (S22).

Referring to FIG. 6, when a message having the ANTS address as a sender and the pANC address as a receiver is delivered from the ANTS 220 to the ANMR 221 (S31), the ANMR 221 delivers this message to the pANC 230 (S32).

Meanwhile, the normal message refers to a message following the initial establishment message among messages communicated between the ANTS 220 and the ANC 130 and is defined as a message communicated in the format of a request and a response to the request. The normal message has a structure in which the ANC 130 requests the ANTS 220 to provide the message and the ANTS responds to the request toward the ANC.

In processing the normal message, the message is analyzed according to three cases and then is sent to the ANC 130 or the pANC 230.

Analysis forms of the message will be discussed. First, if the ANTS performs a response using the address of the requesting ANC in responding to the request from the ANC, a separate message analysis process is not required with respect to the normal message. Second, if a message does not correspond to the above case, the ANMR stores a unicast access terminal identifier (UATI) value upon request from the ANC to the ANTS and then compares it to a UATI value of a responding message for transmission to the ANC or pANC. Third, a message, which does not correspond to the above two cases, is sent to both the ANC and the pANC.

Referring to FIG. 5, if a message having the ANC address as a sender and the ANTS address as a receiver is delivered from the ANC 130 to the ANMR 221 (S23), the ANMR 221 delivers this message to the ANTS 220. Accordingly, when a response message having the ANTS address as a sender and the ANC address as a receiver is delivered from the ANTS 220 to the ANMR 221 (S25), the ANMR 221 delivers this message to the ANC 130 (S26).

Referring to FIG. 6, a message having an arbitrary unicast access terminal identifier (UATI) value as a response ID (reply_id) and the ANTS address as a receiver is delivered from the pANC 230 to the ANTS 220 through the ANMR 221 (S33). At this time, the ANMR 221 is storing the corresponding UATI value.

If a response message having the ANTS address as a sender and the ANC address as a receiver is delivered from the ANTS 220 to the ANMR 221 (S34), the ANMR 221 compares it to the previously stored UATI value to find a corresponding pANC address and delivers a message having the pANC address as a receiver and the ANTS address as a sender to the pANC 230 (S35).

With such a method, the ANMR can route the message, and can also block a message sent to the public network according to security options.

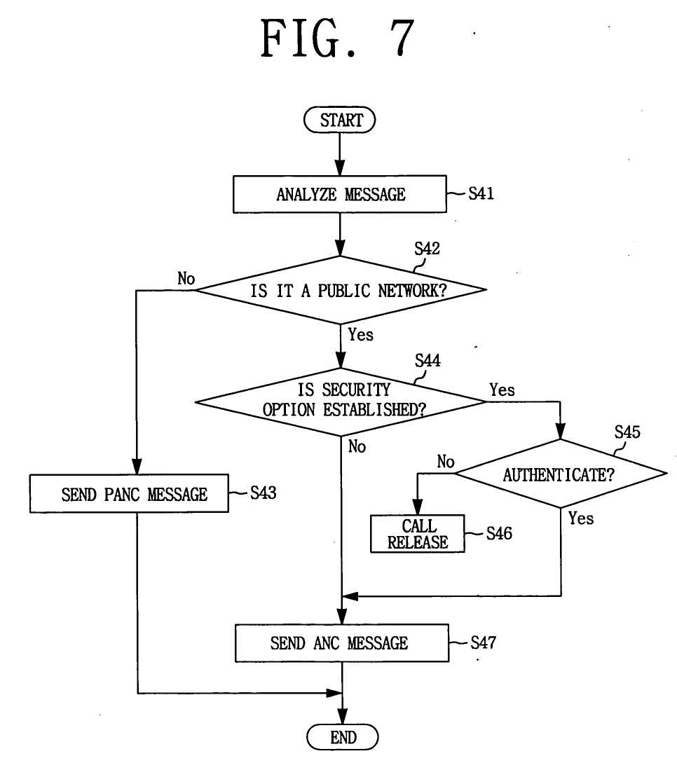

FIG. 7 is a flowchart of a security process performed by an ANMR. Referring to FIG. 7, when receiving messages, the ANTS 220 analyzes a corresponding message (S41). A determination is made as to whether to call the public network as a result of the message analysis (S42). If it is determined that it is not a public network call but a private network call, the ANMR sends a corresponding message to the pANC 230 so that the pANC 230 performs the call processing (S43). Meanwhile, if it is determined that it is the public network call, the ANMR determines whether or not a security option is established (S44). If it is determined that the security option is established, the ANMR performs authentication and determines whether the authentication is successfully completed (S45). If the authentication is not successfully performed, the ANMR terminates the call (S46) while if the authentication is successfully performed, the ANMR sends the message to the ANC 130 through the pANC 230.

A private wireless high-speed data system and a data service method using the same according to an embodiment of the present invention as described above receives session information needed for call processing through the public network DLR to perform the call processing, thereby not needing to separately manage session information of the private network, and does not have a private DLR, thereby reducing cost. In addition, it is possible to prevent the overload of the public network DLR due to an A13 message frequently communicated with the public network DLR, caused when the private DLR is placed.

What is claimed is:

1. A system comprising:
a public EV-DO wireless network having a public network data location register (DLR) and a public network access network control (ANC);
a private EV-DO wireless network interfacing with the public EV-DO wireless network and providing private EV-DO wireless data service, the private EV-DO wireless network comprising:
a private access network control (pANC) coupled to the public network access network control (ANC) and adapted to provide a link between the private EV-DO network and the public EV-DO network, wherein the private access network control (pANC) is adapted to request session information of a private network EV-DO terminal to perform terminal authentication through the public network data location register (DLR) and to allocate a traffic channel and establish a Switched Virtual Circuit (SVC) to provide a private network connection or an Internet connection according to the received session information; and
an access network transceiver system (ANTS) having a defined wireless area, wherein, when one of a public network and a private network is called from a private network EV-DO terminal entering the defined wireless area, the access network transceiver system (ANTS) is adapted to analyze a message sent from the terminal, and to request one of the public network access network control (ANC) or private access network control (pANC) to perform the corresponding public network or private network connection.

2. The system according to claim 1, wherein the link between the private EV-DO network and the public EV-DO network comprises an A14 interface.

3. The system according to claim 1, wherein the public network data location register (DLR) is adapted to store location information and authentication information of either private or public network EV-DO terminals and to provide information needed for call processing upon a call connection from an arbitrary EV-DO terminal being established.

4. The system according to claim 1, wherein the public network data location register (DLR) is adapted to perform at least one of a session creation and release function, a unicast access terminal identifier (UATI) allocation and deletion function, a self database holding function, a session maintenance confirming function, a paging command transmission function, and an interfacing function with a neighboring data location register (DLR).

5. The system according to claim 1, wherein the access network transceiver system (ANTS) comprises a router module adapted to determine whether the originated data call is an originating call for connection to the public network or an originating call for connection to the private network based on an identifier contained in a data call originated from the private network EV-DO terminal, to rout the call to an access network control (ANC) in the public EV-DO network upon the originating call being a public network connection originating call, and to rout the originating call to the private access network control (pANC) to be processed in the private network EV-DO network upon the originating call being a private network connection originating call.

6. The system according to claim 1, further comprising a pAN_AAA adapted to receive session information on an arbitrary private network EV-DO terminal from the public network data location register (DLR) through the private access network control (pANC) to perform authentication for the corresponding terminal.

7. The system according to claim 1, further comprising a private packet data service node (pPDSN) coupled to the private access network control (pANC) and adapted to provide Internet service to the private network EV-DO terminal through an Intranet.

8. The system according to claim 1, further comprising a wireless base system manager (WSM) adapted to perform loading, failure, diagnosis, and statistics in the private EV-DO wireless network according to the traffic channel allocation and the SVC establishment by the private access network control (pANC).

9. A method comprising:
providing a public EV-DO wireless network including a public network data location register (DLR) and a public network access network control (ANC);
interfacing a private EV-DO wireless network with the public EV-DO wireless network;
the private EV-DO wireless network adapted to perform a network connection request including analyzing a message received from a private EV-DO network terminal to request the public network access network control (ANC) to perform a public network connection or to request the private access network control (pANC) to perform a private network connection upon an access network transceiver system (ANTS) receiving one of a public network call request and a private network call request from the private EV-DO network terminal;
the private EV-DO wireless network adapted to perform a session information allocation including requesting and receiving the public network data location register (DLR) to provide terminal session information for terminal authentication performance from the public network access network control (ANC) receiving the public network connection request, or of requesting is and receiving the terminal session information for the terminal authentication performance from the private access network control (pANC) receiving the private network connection request by communication through the public network data location register (DLR); and
the private EV-DO wireless network adapted to perform a network connection including performing the authentication according the received session information and performing the private network connection with the private access network control (pANC) or performing the public network connection with the public network access network control (ANC).

10. The method according to claim 9, wherein the public network data location register (DLR) is adapted to store location information and authentication information of either private or public network EV-DO terminals and to provide information needed for call processing upon a call connection from an arbitrary EV-DO terminal being established.

11. The method according to claim 9, wherein the public network data location register (DLR) is adapted to perform at least one of a session creation and release function, a UATI allocation and deletion function, a self database holding function, a session maintenance confirming function, a paging command transmission function, and an interfacing function with a neighboring data location register (DLR).

12. The method according to claim 9, wherein the access network transceiver system (ANTS) includes a router module adapted to determine whether the originated data call is an originating call for connection to the public network or an originating call for connection to the private network based on an identifier included in a data call originated from the private network EV-DO terminal, to rout the call to an access network control (ANC) in the public EV-DO network upon the originating call being a public network connection originating call, and to rout the originating call to the private access network control (pANC) to be processed in the private network EV-DO network upon the originating call being a private network connection originating call.
